(19) United States
(12) Patent Application Publication
(10) Pub. No.: US 2005/0181744 A1
(43) Pub. Date: Aug. 18, 2005

(54) Multimedia transmission device

(76) Inventor: Chung-Hung Lin, Tainan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/778,241

(22) Filed: Feb. 17, 2004

(51) Int. Cl. H04R 5/00

(52) U.S. Cl. 455/90.3

(57) ABSTRACT

A multimedia transmission equipment has a control circuit, which has an emission circuit, an audio source socket, and operation buttons; the control circuit is made such that when a signal cable is connected to both the audio source socket and an output socket of an audio source appliance at two ends, and when the control circuit is activated, audio source signals stored in the audio source appliance will be transferred from the audio source appliance to the emission circuit, and wirelessly sent out at a determined emission frequency by the emission circuit, thus allowing a radio to receive and play music and sound based on the audio source signals after the radio is tuned to the determined frequency.

### BACKGROUND OF THE INVENTION

1. Field of the invention

The present invention relates to a multimedia transmission equipment, which has a control circuit capable of making an emission circuit wirelessly send out audio source signals stored in an appliance connected to the equipment, thus allowing an ordinary radio to receive and play music and sound based on the audio source signals after the radio is tuned to the same frequency as the emission circuit.

2. Brief Description of the Prior Art

There are a wide variety of electronic audio source equipments for playing music and sound with, e.g. MP3 player and mobile phones.

MP3 players are specially provided for playing MP3 music with. The complete name of MP3 is MPEG (Movie Picture Experts group) 1 Layer 3, which belongs to the MPEG-1 layer. And, the purpose of developing MP3 is to reduce the amount of load consumed in media transmission while the quality of the media is maintained.

However, music is played through loudspeakers and earphones connected to the above audio source equipments, and audio quality can't be improved.

### SUMMARY OF THE INVENTION

It is a main object of the present invention to provide a multimedia transmission equipment, which is used together with an ordinary radio for playing music with better audio quality.

The multimedia transmission equipment of the present invention has a control circuit, which includes an emission circuit, an audio source socket, and operation buttons. The control circuit is made such that when a signal cable is connected to both the audio source socket and an output socket of an audio source appliance at two ends, and when the control circuit is activated, audio source signals stored in the appliance will be transferred from the audio source appliance to the emission circuit, and wirelessly sent out at a determined emission frequency by the emission circuit, thus allowing a radio to receive and play music and sound based on the audio source signals after the radio is tuned to the same frequency.

### BRIEF DESCRIPTION OF THE DRAWINGS

The present invention will be better understood by referring to the accompanying drawings, wherein:

FIG. 1 is a perspective view of the multimedia transmission equipment according to the present invention,

FIG. 2 is a circuit block diagram of the first embodiment in the present invention,

FIG. 3 is a circuit block diagram of the second embodiment,

FIG. 4 is a circuit block diagram of the third embodiment,

FIG. 5 is a circuit block diagram of the fourth embodiment,

FIG. 6 is a circuit block diagram of the fifth embodiment,

FIG. 7 is a circuit block diagram of the sixth embodiment,

FIG. 8 is a circuit block diagram of the seventh embodiment,

FIG. 9 is a perspective front view of an eighth embodiment of a multimedia transmission equipment in the present invention,

FIG. 10 is a perspective rear view of the eighth embodiment, and

FIG. 11 is a circuit block diagram of the eighth embodiment.

### DETAILED DESCRIPTION OF THE PREFERRED EMBODIMENTS

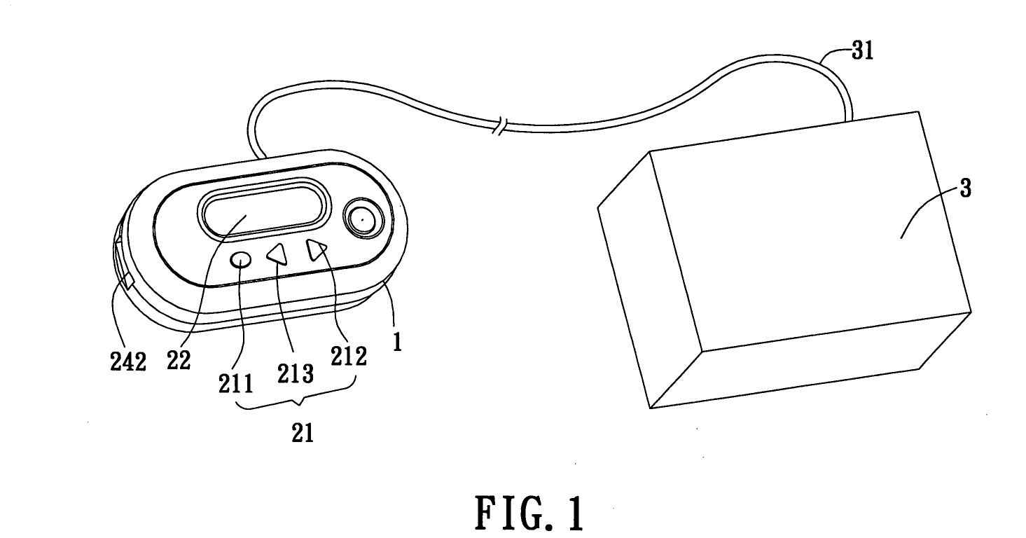

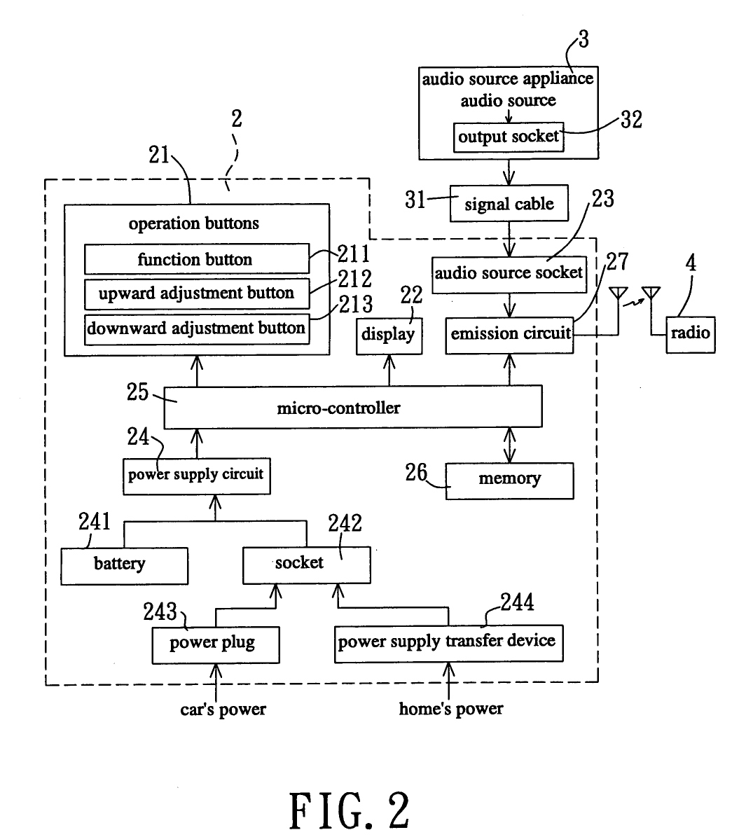

Referring to FIGS. 1 and 2, a first embodiment of a multimedia transmission equipment in the present invention includes a housing 1, and a control circuit 2.

The control circuit 2 includes several operation buttons 21, a display 22, and an audio source socket 23, which are all fitted on an outer side of the housing 1, and includes a power supply circuit 24, a micro-controller 25, a memory 26, and an emission circuit 27.

The operation buttons 21 are used for choosing an operational function as well as adjusting the emission frequency of the emission circuit 27, and includes a function button 211, an upward adjustment button 212, and a downward adjustment button 213. The display 22 is used for displaying operation-related information and the emission frequency thereon, and can be an LCD or an LED monitor. A signal cable 31 is connected to the audio source socket 23, and an output socket 32 of an audio source appliance 3 at two ends such that audio signals can be transferred from the audio source appliance 3 to the emission circuit 27. The power supply circuit 24 can be powered with batteries 241, and can be equipped with a socket 242 thereon for selective connection with a power plug 243 in a car, and a power supply transfer device 244, which is connected to a home's power source; thus, the power supply circuit 24 can be powered with a car's power or a home's power source, and supply suitable and stable power to various circuits of the control circuits 2. The micro-controller 25 can control operation of the circuit 2 with the help of programs prerecorded therein. The memory 26 is used for storing emission frequencies, volumes etc, and can be an electrically erasable programmable read-only memory (EEPROM). The emission circuit 27 is a digital frequency modulated emission circuit, and is activated and controlled by means of the micro-controller 25 such that audio source signals such as music and sound are transmitted at an intended frequency.

To play music, first the signal cable 3 is connected to both the audio source socket 23 and the output socket 32 of audio source appliance 3, e.g. mobile phone, and music player such as MP3 player. And, audio source signals are transferred from the audio source appliance 3 to the emission circuit 27 with the power supply circuit 24 being powered with one of the above three power sources, i.e. batteries 241, power in a car, and home's power supply.

Then, the function button 211 is used to choose an operation mode, and the upward and downward adjustment buttons 212, 213 are used to choose operational function as well as adjust the emission frequency of the emission circuit 27, which operational function and emission frequency will be immediately displayed on the display 22; the control circuit 2 can be made such that the emission frequency, channels, of the emission circuit 27 ranges from 88 MHz to 108 MHz, and channels that are chosen will be made recorded in the memory 26 by the micro-controller 25.

The micro-controller 25 is activated to make the emission circuit 27 transmit audio source signals of the audio source appliance 3 wireless at a chosen channel. And, a radio 4 is tuned to the same channel as the emission circuit 27 to receive the radio signals transmitted from the emission circuit 27 such that sound/music is played through the radio 4. In other words, music in a MP3 player will be played through both a radio and the present transmission equipment when the MP3 player is connected to the present transmission equipment with the cable 31 for use as the audio source appliance 3, and when the radio is tuned to the same channel as the emission circuit 27.

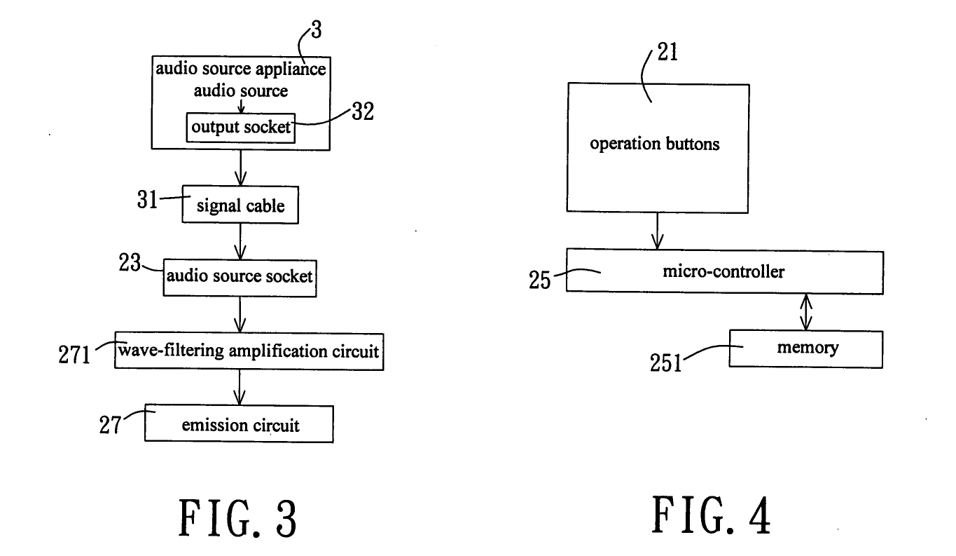

Referring to FIG. 3, in a second embodiment, wave-filtering amplification circuits 271 are electrically connected to input and output terminals of the emission circuit 27 such that audio source signals transferred from the audio source appliance 3 to the emission circuit 27 are filtered, and amplified to have better audio quality.

Referring to FIG. 4, in a third embodiment, the micro-controller 25 has a memory 251 connected thereto, which has music and audio signals stored therein; the music and audio signals will be played through a radio 4 tuned to the same channel as the emission circuit 27 when the emission circuit 27 is transmitting the signals. Furthermore, repeat mode can be chosen with the help of the operation buttons 21 such that the music and audio signals in the memory 251 are repeatedly played.

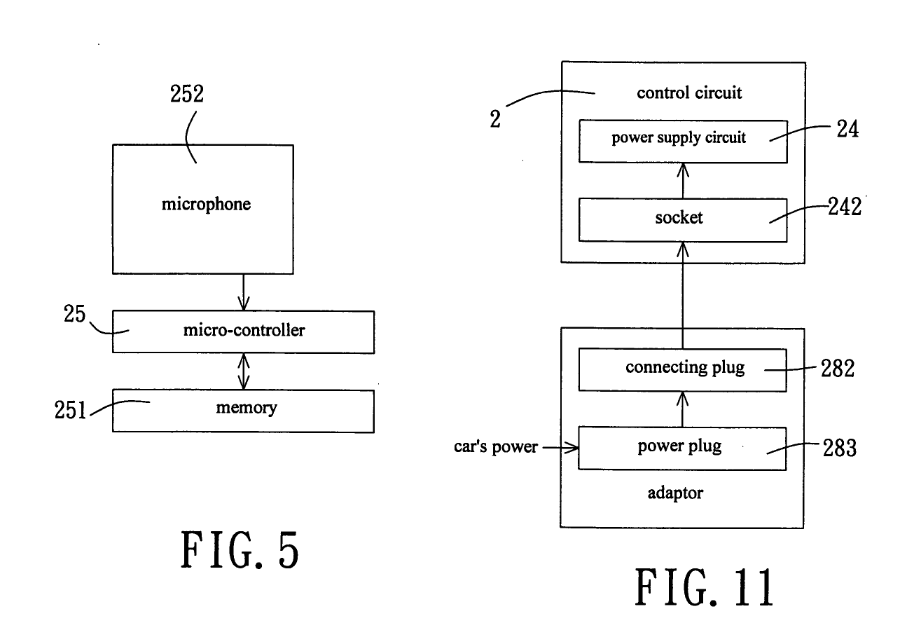

Referring to FIG. 5, in a fourth embodiment, the micro-controller 25 has memory 251, and a microphone 252 connected thereto; thus, the micro-controller 25 can make sound stored in the memory 251 through the microphone 252, and the sound can be played afterwards.

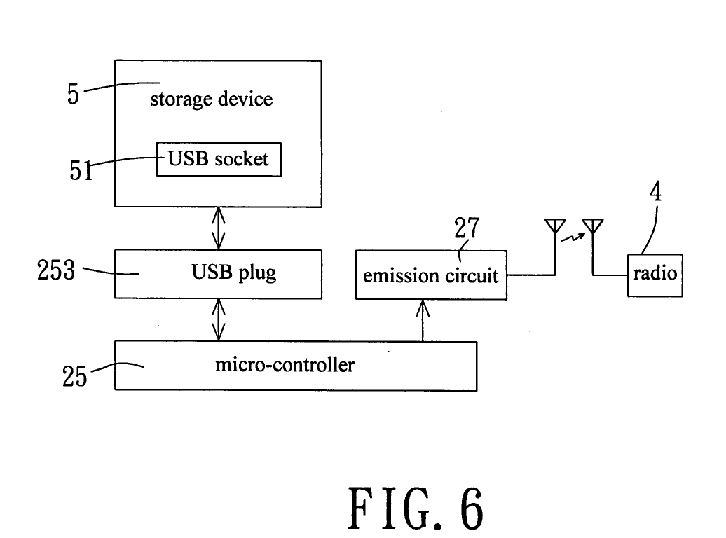

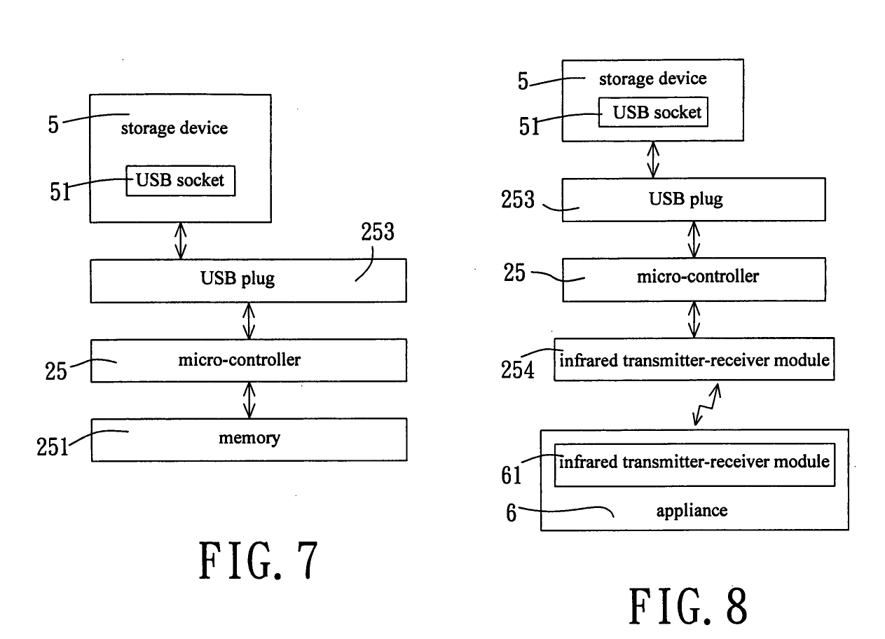

Referring to FIG. 6, in a fifth embodiment, the micro-controller 25 has an USB plug 253 connected thereto; thus, the micro-controller 25 will be electrically connected to a storage device 5, in which music and audio data can be stored, e.g. computer, portable hard disk, and card reader when the USB plug 253 is connected to an USB socket 51 of the storage device 5. Consequently, the micro-controller 25 can read and process the music and audio data in the storage device 5, and make the emission circuit 27 transmit radio signals at a chosen channel for allowing music and sound to be played through a radio 4 tuned to the same channel as the emission circuit 27.

Referring to FIG. 6, in a sixth embodiment, the micro-controller 25 has a memory 251, and an USB plug 253 connected thereto; thus, the micro-controller 25 will be electrically connected to a storage device 5, in which music and audio data are stored, e.g. computer, portable hard disk, and card reader, when the USB plug 253 is connected to an USB socket 51 of the storage device 5. Therefore, data can be transferred from the storage device 5 to the memory 251 and from the memory 251 to the storage device 5.

Referring to FIG. 8, in a seventh embodiment, the micro-controller 25 has an USB plug 253 connected thereto; thus, the micro-controller 25 can be electrically connected to a storage device 5 that can store music and audio data therein when the USB plug 253 is connected to an USB socket 51 of the storage device 5. Furthermore, the micro-controller 25 has an infrared transmitter-receiver module 254 connected thereto; thus, when the storage device 5 is connected to the present equipment, data can be wirelessly transferred from the storage device 5 to another appliance 6, which is equipped with an infrared transmitter-receiver module 61, and from the appliance 6 to the storage device 5; the appliance 6 can be a computer, mobile phone or PDA equipped with an infrared transmitter-receiver module.

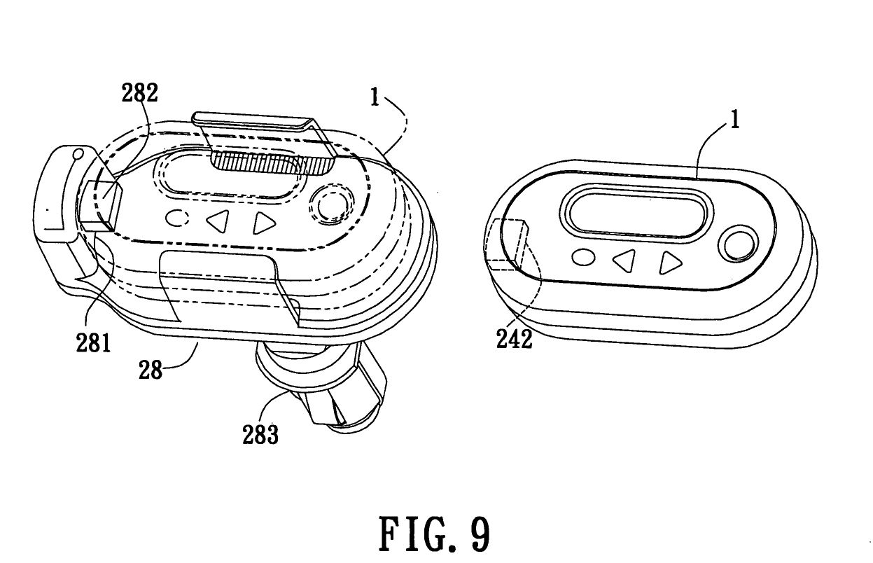

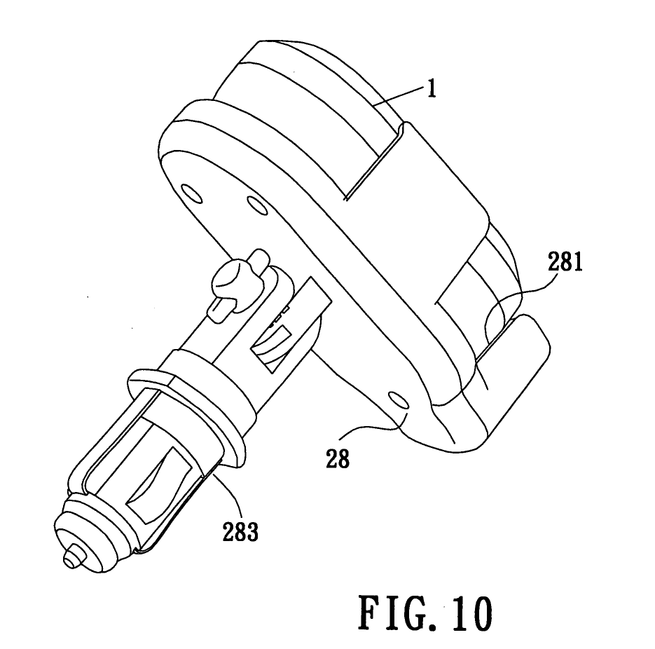

Referring to FIGS. 9 to 11, in an eighth embodiment, an adaptor 28 is used for connecting the present multimedia transmission equipment to a power supply socket in a car. The adaptor 28 has a holding cavity 281, a connecting plug 282 in the holding cavity 281, and a power plug 283 for use in a car, which plug 283 is formed on a back of the adaptor 28, and electrically connected to the connecting plug 282. To use the present equipment in a car, the housing 1 is fitted in the holding cavity 281 of the adaptor 28 with the connecting plug 282 being fitted in the socket 242, and the plug 283 is connected to a power socket in the car such that power of the car is supplied to the control circuit 2 through the plugs 283, 282, and the socket 242.

From the above description, it can be easily understood that the present invention has the following advantages:
1. When the present equipment is connected to audio source appliance 3, and activated, music and audio data will be transferred from the audio source appliance 3 to the present equipment, and the emission circuit 27 will transmit the data wirelessly at a chosen channel; thus, music and sound are played through an ordinary radio 4 tuned to the same channel as the emission circuit 27. Therefore, the present equipment is convenient to use.
2. Because music is played through a radio, stereophonic effects and high quality will be produced when a high class radio is used.
3. In the third embodiment (FIG. 4), the micro-controller 25 has a memory 251 connected thereto, in which music and audio signals are stored. Therefore, when the emission circuit 27 transmits the music and audio signals, the signals will be played through a radio 4 tuned to the same channel as the emission circuit 27.
4. In the fourth embodiment (FIG. 5), the micro-controller 25 has memory 251, and a microphone 252 connected thereto. Therefore, sound can be stored in the memory 251 through the microphone 252, and the sound can be played afterwards.
5. In the fifth embodiment (FIG. 6), the micro-controller 25 will be connected to the storage device 5, in which music and audio data are stored, when the USB plug 253 is connected to the USB socket 51 of the storage device 5. Therefore, the music and audio data in the storage device 5 can be wirelessly transmitted through the present transmission equipment and played through a radio tuned so as to receive radio signals from the present transmission equipment.
6. In the sixth embodiment, the micro-controller 25 will be electrically connected to the storage device 5, in which music and audio data are stored, when the USB plug 253 is connected to the USB socket 51. Therefore, data can be transferred from the storage device 5 to the memory 251 and from the memory 251 to the storage device 5.
7. In the seventh embodiment (FIG. 8), the micro-controller 25 will be connected to the storage device 5 when the USB plug 253 is inserted in the USB socket 51. And, data can be wirelessly transferred from the storage device 5 to the appliance 6, which can be a computer, mobile phone or PDA, and from the appliance 6 to the storage device 5 through both the infrared transmitter-receiver modules 254 and 61.
8. The eighth embodiment (FIGS. 9 to 11) can be powered with the power supply of a car with the help of the adaptor 28.

1. A multimedia transmission equipment, comprising
a housing; and
a control circuit, the control circuit having an emission circuit held in the housing; the control circuit having an audio source socket and a plurality of operation buttons fitted on an outer side of the housing;
the control circuit being made such that when a signal cable is connected to both the audio source socket and an output socket of an audio source appliance at two ends, and when the control circuit is activated, audio source signals stored in the audio source appliance will be transferred from the audio source appliance to the emission circuit, and wirelessly sent out at a determined emission frequency by the emission circuit, thus allowing a radio to receive and play music and sound based on the audio source signals after the radio is tuned to the determined frequency.

2. The multimedia transmission equipment as claimed in claim 1, wherein the operation buttons are used for choosing an operational function as well as adjusting emission frequency of the emission circuit, and includes a function button, an upward adjustment button, and a downward adjustment button while the control circuit further has a display connected thereto for displaying operation-related information and emission frequency of the emission circuit thereon.

3. The multimedia transmission equipment as claimed in claim 1, wherein the control circuit has a memory connected thereto, in which a plurality of different frequencies are stored, and the emission frequency of the emission circuit is chosen from the plurality of different frequencies by means of the operation buttons.

4. The multimedia transmission equipment as claimed in claim 1, wherein the control circuit has a memory connected thereto for allowing music and audio data to be stored therein.

5. The multimedia transmission equipment as claimed in claim 1, wherein the control circuit has a memory, and a microphone connected thereto such that audio data can be stored in the memory through the microphone.

6. The multimedia transmission equipment as claimed in claim 1, wherein the micro-controller has an USB plug connected thereto such that when the micro-controller is electrically connected to a storage device, in which music and audio data are stored, with the USB plug being connected to an USB socket of the storage device, the music and audio data will be transferred from the storage device to the emission circuit, transmitted by the emission circuit, and played through the radio.

7. The multimedia transmission equipment as claimed in claim 1, wherein the micro-controller has a memory, and an USB plug connected thereto such that when the micro-controller is electrically connected to a storage device, in which music and audio data are stored, with the USB plug being connected to an USB socket of the storage device, data can be transferred from the storage device to the memory and from the memory to the storage device.

8. The multimedia transmission equipment as claimed in claim 1, wherein the micro-controller has an infrared transmitter-receiver module and an USB plug connected thereto; thus, when a storage device is connected to the USB plug at an USB socket thereof, data can be wirelessly transferred from the storage device to a second appliance, which is equipped with an infrared transmitter-receiver module, and from the second appliance to the storage device.

9. The multimedia transmission equipment as claimed in claim 1 being further provided with an adaptor for connecting it to a car's power supply, which adaptor has a holding cavity for allowing insertion of the housing therein, a connecting plug in the holding cavity for connection with a power supply socket of the control circuit, and a power plug formed on a back of the adaptor and electrically connected to the connecting plug for allowing a car's power to be supplied to the control circuit through it.

10. The multimedia transmission equipment as claimed in claim 1, wherein:
the operation buttons are used for choosing an operational function as well as adjusting emission frequency of the emission circuit, and includes a function button, an upward adjustment button, and a downward adjustment button;
the control circuit has a display connected thereto for displaying operation-related information and emission frequency of the emission circuit thereon;
the control circuit has a power supply circuit connected thereto for converting power into stable one for use thereon;
the control circuit has a micro-controller having programs prerecorded therein for controlling operation of various parts of the control circuit;
the control circuit has a memory for allowing emission frequencies and volumes to be stored therein;
the emission circuit is a digital frequency modulated emission circuit, and is activated and controlled by means of the micro-controller such that audio source signals are transmitted at a determined frequency.

11. The multimedia transmission equipment as claimed in claim 10, wherein wave-filtering amplification circuits are electrically connected to the emission circuits such that audio source signals transferred from the audio source appliance are filtered, and amplified.

12. The multimedia transmission equipment as claimed in claim 10, wherein the memory of the control circuit has a plurality of different frequencies stored therein, from which the emission frequency of the emission circuit is chosen by means of the operation buttons.

13. The multimedia transmission equipment as claimed in claim 10, wherein the power supply circuit is powered with batteries.

14. The multimedia transmission equipment as claimed in claim 10, wherein the power supply circuit has a socket connected thereto, which is used for connection with a car's power.

15. The multimedia transmission equipment as claimed in claim 10, wherein the power supply circuit has a socket connected thereto, which is connected to a power supply transfer device such that a home's power is supplied to the power supply circuit.
